(19) United States
(12) Patent Application Publication
(10) Pub. No.: US 2012/0080160 A1
(43) Pub. Date: Apr. 5, 2012

(54) Regenerative Heat Exchanger and Seal Apparatus Employing Labyrinth Seal

(76) Inventors: Randolph G. Townsend, Fleming, OH (US); Eric Leon McRobert, Little Hocking, OH (US); Edward Joseph Hensler, Waterford, OH (US)

(21) Appl. No.: 12/896,159

(22) Filed: Oct. 1, 2010

(51) Int. Cl. F28D 17/00; F16J 15/02

(52) U.S. Cl. 165/4; 277/641

(57) ABSTRACT

An improved regenerative heat exchanger and seal assembly employ a plurality of instances of a seal apparatus, with each seal apparatus including a seal member that includes a seal tab that extends from one end of the seal member and further includes a corresponding notch at the opposite end of the seal member. The seal tab is receivable in a notch of an adjacent seal apparatus, and the engagement of the seal tabs in the notches creates a labyrinth seal by providing a tortuous path that resists the flow of exhaust gases and air past the seal assembly.

### BACKGROUND

1. Field

The disclosed and claimed concept relates generally to a regenerative heat exchanger and, more particularly, to a regenerative heat exchanger and a seal apparatus that employs a labyrinth seal.

2 Related Art

Regenerative heat exchangers and seals employed therein are generally known in the relevant art, an example of which is presented in U.S. Pat. No. 4,997,028, the disclosures of which are incorporated herein by reference. A regenerative heat exchanger employs the heat of the exhaust gases of a burner, such as in a power plant, to heat the inlet air to the burner to improve the burner's efficiency. A typical regenerative heat exchanger includes a stationary housing within which is disposed a rotating heat exchanging body. The heat exchanging body includes a plurality of fins that each extend radially between a central hub and a cylindrical outer wall, with the cylindrical outer wall typically being disposed in relatively close proximity to a cylindrical wall of the stationary housing. An exhaust gas duct and a separate inlet air duct are connected with the stationary housing and pass exhaust gas and inlet air, respectively, through the housing and into heat exchange contact with the radially extending fins of the rotating heat exchanging body.

In order to resist contamination of the inlet air with exhaust gases, seals are typically mounted to the radially extending fins of the heat exchanging body and extend into contact with the housing, with such seals moving with the heat exchanging body as it rotates within the housing. For example, if the heat exchanging body rotates about a vertical axis, the fins extend horizontally between the hub and the cylindrical outer wall, and the seals extend from upper and lower edges of the fins into contact with flat interior surfaces of the stationary housing.

Additional seals typically extend between the cylindrical outer wall of the heat exchanging body and the cylindrical wall of the housing. Such additional seals are provided in order to resist the exhaust gases and inlet air from flowing through the annular space between the outer wall of the heat exchanging body and the cylindrical wall of the housing, because such flow thought the annular space would undesirably cause the exhaust gases and inlet air to avoid the radial fins of the heat exchanging body, whereby the desired heat transfer would not occur.

The seals themselves typically include a seal element that is formed of a heat resistant material that is at least partially metallic and is typically manufactured from materials such as those that are used to manufacture brake shoes. The seal element typically is mounted to a sheet metal support that is connected with either the heat exchanging body or the housing, with the seal element being sealingly engaged with the other of the heat exchanging body and the housing. Most typically, the seal element is on the order of roughly three or four inches in length, and thus a large number of seal elements and their sheet metal supports are connected together to form an elongated seal assembly that extends about the circumference of a regenerative heat exchanger which may be on the order of twenty feet in diameter.

In order to resist the flow of exhaust gases and air through the small space that may exist between each adjacent pair of seal elements, each individual sheet metal support also includes an outwardly extending lip. The lip is situated close to the seal element and extends parallel with the seal element and at nearly the height of the seal element so that the edge of the lip is disposed in close proximity yet slightly spaced from whichever surface of the heat exchanging body and the housing is engaged by the seal element. The lips thus provide a further barrier to the flow of exhaust gases and air through gaps between the seal elements.

In operation, the exhaust gases flow over and past the radially extending fins of the heat exchanging body and heat the fins. The heated fins then rotate with the heat exchanging body out of communication with the exhaust gas duct and into heat exchange relation with the inlet air flowing within the air duct. The inlet air is thereby heated and flows into the burner of the power plant. The cooled fins are then rotated back into contact with the exhaust gases.

While such seals have been generally effective for their intended purposes, they have not been without limitation. For instance, since the seal element sealingly slides along a surface of either the heat exchanging body or the housing (or on a wear band disposed thereon), the seal elements experience wear due to friction and must be periodically replaced, which is costly. Moreover, the edges of the aforementioned lips are intended to be spaced from the surface that is engaged by the seal elements and are intended to therefore not contact such surface. However, as the seal elements wear they lose material, and the lip can thus become engaged with and wear against the surface of the heat exchanging body or the housing, which is undesirable. It thus would be desirable to provide an improved seal and regenerative heat exchanger that address these and other shortcomings associated with known seals.

### SUMMARY

An improved regenerative heat exchanger and seal assembly employ a plurality of instances of a seal apparatus, with each seal apparatus including a seal member that includes a seal tab that extends from one end of the seal member and further includes a corresponding notch at the opposite end of the seal member. The seal tab is receivable in a notch of an adjacent seal apparatus, and the engagement of the seal tabs in the notches creates a labyrinth seal by providing a tortuous path that resists the flow of exhaust gases and air past the seal assembly. The improved seal assembly also advantageously avoids the need to provide an additional lip such as has been known in the relevant art to provide a further barrier to the flow of exhaust gases and air through gaps between adjacent seal elements. This reduces cost and also avoids the possibility of destructive wear that sometimes can occur between such a lip and the surface of the heat exchanging body or the housing of the regenerative heat exchanger against which the seal member is sealingly disposed.

Accordingly, an aspect of the disclosed and claimed concept is to provide an improved seal apparatus that provides improved sealing by employing a notch and a tab in each seal member to provide a labyrinth seal.

Another aspect of the disclosed and claimed concept is to provide an improved regenerative heat exchanger employing such an improved seal apparatus.

### BRIEF DESCRIPTION OF THE DRAWINGS

A further understanding of the disclosed and claimed concept can be gained from the following Description when read in conjunction with the accompanying drawings in which:

FIG. 1 is a perspective view of an improved seal apparatus in accordance with the disclosed and claimed concept;

FIG. 2 is a cut away view of a regenerative heat exchanger in accordance with the disclosed and claimed concept that employs the seal apparatus of FIG. 1;

FIG. 3 is a view of a seal assembly that employs the seal apparatus of FIG. 1;

FIG. 4 is a top view of the seal assembly of FIG. 3; and

FIG. 5 is an enlarged view of portions of an encircled region of FIG. 2.

Similar numerals refer to similar parts throughout the specification.

### DESCRIPTION

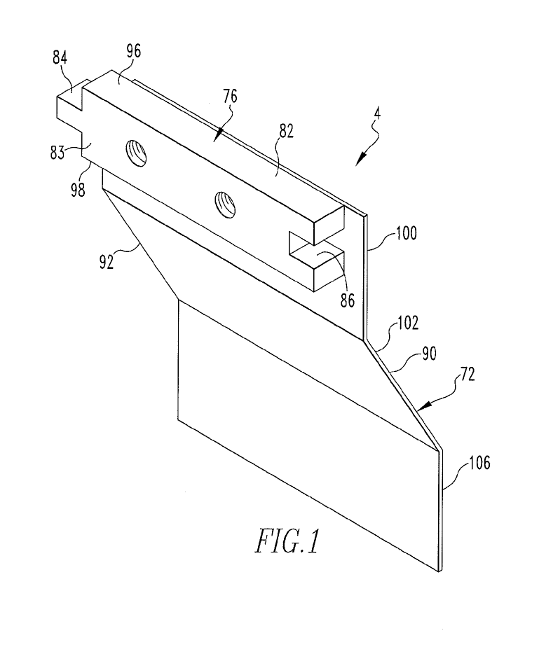

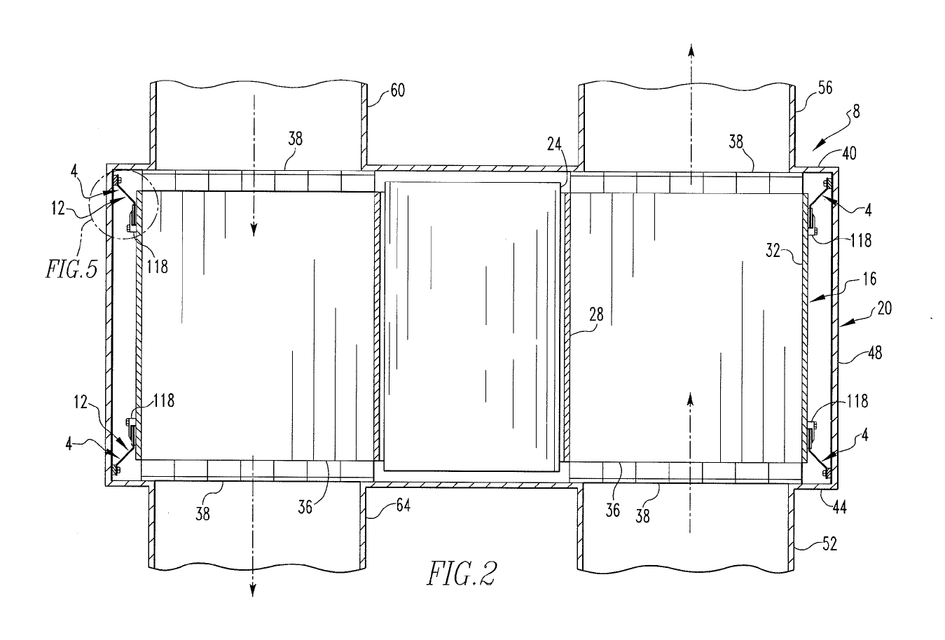

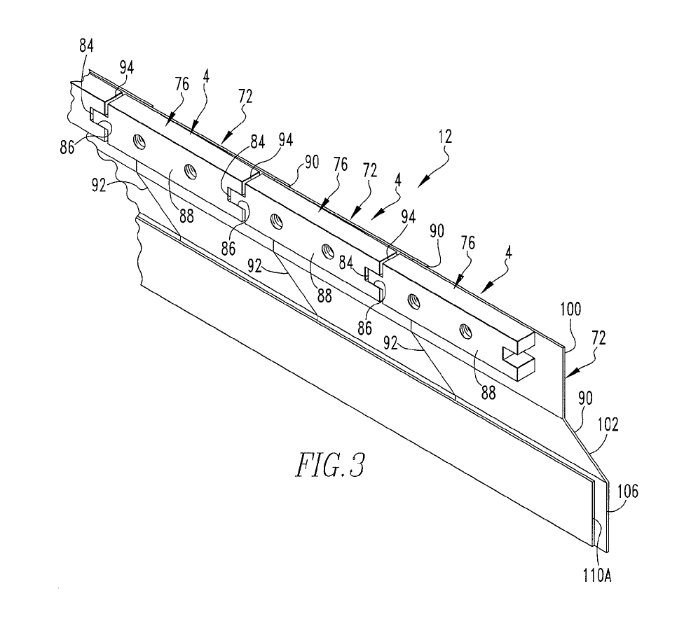

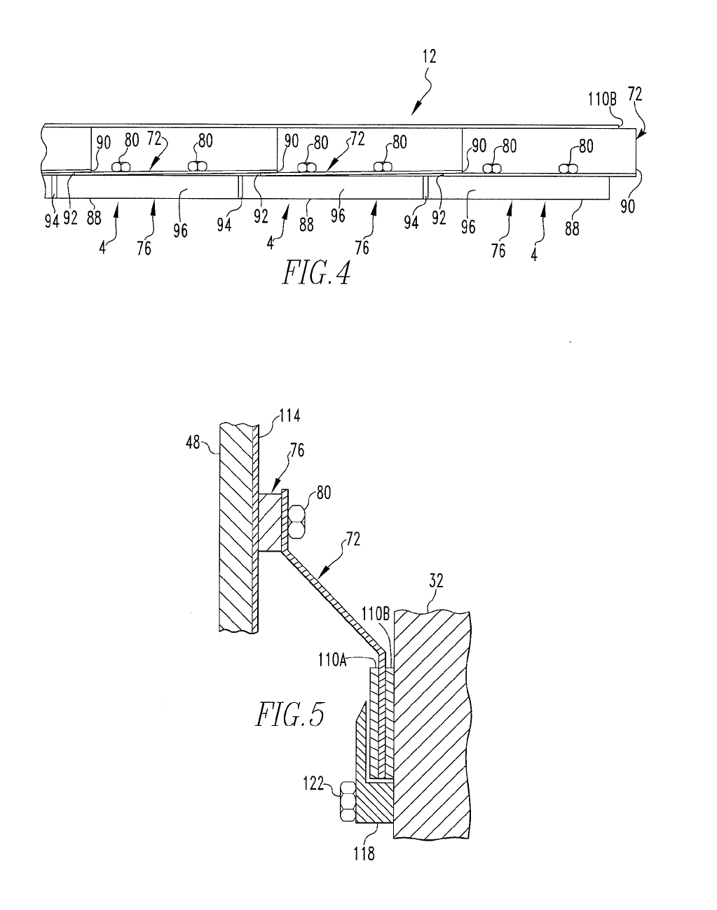

An improved seal apparatus 4 is depicted in FIG. 1 and is also depicted in whole or in part in FIGS. 2-5. The seal apparatus 4 can be employed in an improved regenerative heat exchanger 8, such as is depicted schematically in FIG. 2. In such an application, a plurality of instances of the seal apparatus 4 are assembled together to form a seal assembly 12, such as is indicated generally in FIGS. 3 and 4, which are installed into the regenerative heat exchanger 8.

As can be understood from FIG. 2, the regenerative heat exchanger 8 includes a substantially cylindrical heat exchanging body 16 that is rotatingly disposed within a substantially cylindrical and stationary housing 20. The heat exchanging body 16 comprises an axle 24, an annular inner wall 28 which serves as a hub, an annular outer wall 32, and a plurality of generally planar fins 36 that each extend between the inner and outer walls 28 and 32. From the perspective of FIG. 2, the fins 36 are oriented substantially vertically. An axial seal 38 is disposed at the upper and lower edge of each fin 36 from the perspective of FIG. 2. The axial seals 38 protrude vertically the fins 36, from the perspective of FIG. 2, and sealingly engage the housing 20.

The housing 20 itself includes a first plate 40 and a second plate 44 which, from the perspective of FIG. 2, are oriented horizontally. The housing 20 further comprises a cylindrical connecting wall 48 that extends between the first and second plates 40 and 44. The housing 20 further includes an exhaust gas entry duct 52, an exhaust gas exit duct 56, an inlet air entry duct 60, and an inlet air exit duct 64. The exhaust gas entry duct 52 and the inlet air exit duct 64 are disposed on the second plate 44, and the exhaust gas exit duct 56 and the inlet air entry duct 60 are disposed on the first plate 40. As can be understood from FIG. 2, exhaust gases enter the regenerative heat exchanger 8 through the exhaust gas entry duct 52 and flow over and past the fins 36, thereby heating the fins 36. The exhaust gases then flow out of the regenerative heat exchanger 8 via the exhaust gas exit duct 56. Since the heat exchanging body 16 is continuously rotating about the axle 24 within the housing 20, the heated fins 36 are rotated into heat exchange contact with inlet air that flows into the regenerative heat exchanger 8 through the inlet air entry duct 60. The inlet air flows over and past the heated fins 36, which warms the inlet air, after which the inlet air flows out of the inlet air exit duct 64 and into the burner (not expressly depicted herein) in connection with which the regenerative heat exchanger 8 is employed.

In the embodiment shown in FIG. 2, two instances of the seal assembly 12 are affixed to a radially outermost surface of the outer wall 32 and are slidingly engaged with an inner surface of the connecting wall 48. It is understood that other configurations are possible without departing from the present concept. For instance, the seal assemblies 12 could instead each be configured to be slidingly engaged with the interior surfaces of the first and second plates 40 and 44. Still alternatively, the seal assemblies 12 could be affixed to the housing 20 and the slidingly engaged with the heat exchanging body 16.

As can be understood from Fig. I, each seal apparatus 4 comprises a support 72 and a seal member 76 affixed to the support 72. In the exemplary embodiment depicted herein, the seal member 76 is affixed to the support 72 with a pair of fasteners 80 (FIGS. 4 and 5) which are depicted herein as being threaded bolts. It is understood that the seal member 76 could be affixed to the support 72 in other fashions without departing from the present concept, such as through the use of non-threaded fasteners such as rivets, through the use of adhesives, or through welding techniques, by way of example.

The support 72 is fashioned from a heat resistant sheet metal such as a high chromium content stainless steel, many examples of which are known in the relevant art. The seal member 76 is formed from a material that is resistant to friction wear and is typically manufactured at least partially of metallic materials or ceramic materials or both. The seal member 76 often is formed of materials similar to those which are used for the manufacture of brake shoes.

The seal member 76 itself comprises an elongated seal body 82, at one end of which is disposed a protruding seal tab 84, and at an opposite end which is formed a notch 86. A sealing surface 88 extends across the entirety of the seal member 76 and, in particular, extends across the seal body 82 including the region of the notch 86, and further extends across the seal tab 84. The sealing surface 88 may be substantially planar, at least initially, i.e., prior to wear that may occur from sliding contact with a corresponding surface of the regenerative heat exchanger 8.

As can be further understood from FIG. 1, the end of the seal body 82 wherein the notch 86 is formed is spaced from a first side 90 of the support 72. Moreover, an opposite end of the seal body 82 that is disposed in the vicinity of a second side 92 of the support 72 actually protrudes beyond the second side 92, and the seal tab 84 is itself disposed in its entirety beyond the second side 92.

As mentioned above, a plurality of instances of the seal apparatus 4 can be assembled together to form the seal assembly 12 as is indicated in FIGS. 3 and 4. In forming the sealing assembly 12, the seal tab 84 of the seal member 76 of one seal apparatus 4 is receiving in a notch 86 of a seal member 76 of an adjacent seal apparatus 4, and so forth. In so doing, the second side 92 of the support 72 of the seal apparatus 4 whose seal tab 84 is received in a notch 86 of an adjacent seal apparatus 4 likewise overlaps the first side 90 of the support 72 of such adjacent seal apparatus 4. Such overlapping of adjacent supports 72 resists leakage of exhaust gases and inlet air past or between the supports 72 themselves. In the assembled condition of the seal assembly 12 as indicated in FIGS. 3 and 4, the seal member 76 of a seal apparatus 4 at least partially overlaps the support 72 of an adjacent seal apparatus 4, and the seal tab 84 of the seal apparatus 4 is received in the notch 86 of the adjacent seal apparatus 4. The reception of a seal tab 84 in a notch 86 of an adjacent seal apparatus 4 advantageously forms a labyrinth seal 94 between each such corresponding seal tab 84 and notch 86 by providing a tortuous path between a first surface 96 and a second surface 98 of each seal member 76.

As can be understood from FIGS. 1, 3, and 5, the support 72 can be said to comprise an engagement portion 100 to which the seal member 76 is affixed, a transition portion 102, and a connection portion 106 which, in the exemplary embodiment depicted herein, is affixed to the heat exchanging body 16. In forming the seal assembly 12 from a plurality of instances of the seal apparatus 4, the second side 92 of one seal apparatus 4 is positioned to overlap a first side 90 of an adjacent seal apparatus 4, with the seal tab 84 of the one seal apparatus 4 being received in the notch 86 of the adjacent seal apparatus 4, and with at least a portion of the seal body 82 of the one seal apparatus at least partially overlapping the engagement portion 100 of the support 72 of the adjacent seal apparatus 4. A pair of connection plates 110A and 110B are spot welded to opposite sides of the connection portion 106. The seal assembly 12 can be assembled in other fashions without departing from the present concept.

The seal assembly 12 can be assembled with a large quantity of the seal apparatuses 4 into a single piece for installation into the regenerative heat exchanger 8, but it is more likely that the seal assembly 12 will be assembled in a number of pieces, such as by assembling together fifteen or twenty adjacent seal apparatuses 4, by way of example, along with appropriately sized connection plates 110A and 110B. The seal assembly 12, in whatever configuration, is then affixed to the outer wall 32 of the heat exchanging body 16 by receiving it in a number of clamps 118 and tightening a number of fasteners 122, both of which are components of the heat exchanging body 16, as is depicted generally in FIGS. 2 and 5. As can be further understood from FIG. 5, the housing 22 further comprises a wear band 114 that extends about an interior surface of the connecting wall 48 and which is directly engaged by the sealing surface 88 of the seal members 76. The wear band 114 is provided in order to avoid directly wearing away portions of the housing 20, by way of example, by providing a relatively replaceable and individually configurable wear band 114. While not depicted in FIG. 2 for purposes of clarity, a pair of wear bands 114 are provided on the connecting wall 48, one being adjacent the first plate 40, and the other being adjacent the second plate 44.

The improved seal apparatus 4 with its labyrinth seals 94 advantageously provides improved sealing performance when compared with known seals used in regenerative heat exchangers. Moreover, since the provision of the labyrinth seals 94 avoids the need to additionally provide a lip adjacent the first surfaces 96 of the seal members 76, cost is reduced. Furthermore, by avoiding the need to provide such a lip adjacent the first surface 96 of the seal members 76, the potential for enhanced wear of the connecting wall 48 due to engagement of such a lip against the connecting wall 48 due to wearing away of the seal members 76 is advantageously avoided.

While specific embodiments of the disclosed and claimed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed and claimed concept which is to be given the full breadth of the claims appended and any and all equivalents thereof.

What is claimed is:

1. A seal apparatus structured to be used along with a plurality of other similar seal apparatuses in forming a seal assembly for use in a regenerative heat exchanger, the seal apparatus comprising:
a support structured to be mounted to a portion of the regenerative heat exchanger; and
a seal member disposed on the support and comprising a seal body and a seal tab, the seal body having a notch formed therein, the notch being structured to receive therein at least a portion of a seal tab of an adjacent seal apparatus of the seal assembly disposed at a first side of the support, the seal tab protruding from the seal body and being structured to be at least partially received in a notch of another adjacent seal apparatus of the seal assembly disposed at a second side of the support.

2. The seal apparatus of claim 1 wherein the seal body is elongated, and wherein the seal tab and the notch are disposed at opposite ends of the seal body.

3. The seal apparatus of claim 2 wherein the seal tab and a portion of the seal body protrude beyond the second side of the support and are structured to overlie a portion of a support of the another seal apparatus, the second side of the support being structured to be disposed adjacent the support of the another seal apparatus.

4. The seal apparatus of claim 1 wherein the seal member has a sealing surface that extends across the seal body and the seal tab, wherein the support is structured to be mounted to a first portion of the regenerative heat exchanger, and wherein at least a portion of the sealing surface is structured to engage a second portion of the regenerative heat exchanger.

5. The seal apparatus of claim 4 wherein the sealing surface is substantially planar, the notch being disposed adjacent the sealing surface.

6. A seal assembly comprising a plurality of instances of the seal apparatus of claim 1 and at least a first elongated connection plate, at least a portion of the support of each seal apparatus being affixed to the connection plate.

7. A regenerative heat exchanger comprising:
a housing;
a heat exchanging body disposed within the housing, at least one of the heat exchanging body and the housing being movable with respect to the other; and
a seal assembly mounted to one of the heat exchanging body and the housing, the seal assembly comprising a plurality of seal apparatuses;
each seal apparatus comprising:
a support mounted to the one of the heat exchanging body and the housing, and
a seal member disposed on the support and comprising a seal body and a seal tab, the seal body having a notch formed therein, the notch having received therein at least a portion of a seal tab of an adjacent seal apparatus of the seal assembly disposed at a first side of the support, the seal tab protruding from the seal body and being at least partially received in a notch of another adjacent seal apparatus of the seal assembly disposed at a second side of the support.

8. The regenerative heat exchanger of claim 7 wherein, for each seal apparatus, the seal body is elongated, and the seal tab and the notch are disposed at opposite ends of the seal body.

9. The regenerative heat exchanger of claim 8 wherein, for each seal apparatus, the seal tab and a portion of the seal body protrude beyond the second side of the support and overlie a portion of a support of the another seal apparatus, the second side of the support being disposed adjacent the support of the another seal apparatus.

10. The regenerative heat exchanger of claim 7 wherein, for each seal apparatus, the seal member has a sealing surface that extends across the seal body and the seal tab, at least a portion of the sealing surface being engaged with the other of the heat exchanging body and the housing.

11. The regenerative heat exchanger of claim 10 wherein the one of the heat exchanging body and the housing comprises an arcuate surface to which the seal assembly is mounted, the arcuate surface extending about a central axis, and one of:
the sealing surfaces each facing generally toward the central axis, and
the sealing surfaces each facing generally away from the central axis.

12. The regenerative heat exchanger of claim 11 wherein the other of the heat exchanging body and the housing comprises a wear band, the sealing surface being engaged with the wear band.

13. The regenerative heat exchanger of claim 10 wherein the sealing surface is substantially planar, the notch being disposed adjacent the sealing surface.

14. The regenerative heat exchanger of claim 7 wherein the seal assembly further comprises at least a first elongated connection plate, at least a portion of the support of each seal apparatus being affixed to the connection plate.
